(19) United States
(12) Patent Application Publication
(10) Pub. No.: US 2021/0019703 A1
(43) Pub. Date: Jan. 21, 2021

(54) Method for automatic dynamic multiple building floor plan generation

(71) Applicants: Adi Shavit, (US); Noam Eli Gat, (US); Eitan Sarfati, (US)

(72) Inventors: Adi Shavit, (US); Noam Eli Gat, (US); Eitan Sarfati, (US)

(73) Assignee: Buildos LTD., Tel Aviv (IL)

(21) Appl. No.: 16/907,325

(22) Filed: Jun. 22, 2020

Related U.S. Application Data
(60) Provisional application No. 62/866,666, filed on Jun. 26, 2019.

(51) Int. Cl. G06Q 10/10; G06F 16/245

(52) U.S. Cl. CPC G06Q 10/101; G06Q 10/0875; G06F 16/245

(57) ABSTRACT

Dynamic building spaces are a major business nowadays, due to the high rate of change in building utilization—but for building landlords the high pace of change of types of units and their requirements is a major problem as it requires high time and cost consuming efforts. The described inventions will provide per an existing building empty space multiple options which can be offered to a potential tenant and then adapted to his specific needs with a guidance for quick reassembly.

### FIELD OF THE INVENTION

Automatic generation of architectural plans.

### BACKGROUND

Automatic generation of architectural plans is a market requirement to significantly lower the cost and time of redesigns in a dynamic market.

Exiting technology based on tile systems fail to tailor room sizes to the actual floor plans. Other systems attempting to automatically generate architectural programs or floorplans do not address issues of assembly using modular parts nor issues of reassembly between two floor plans. Systems for Automated MEP (mechanical Electrical Plumbing) designs fail to account for future office remodeling and retargeting, which requires tearing down the installed MEP systems and replacing them with new ones. Replacing MEP systems is very expensive process in terms of time, money, transportation and environmental waste.

### SUMMARY OF THE PRESENT INVENTION

The purpose of the described invention is to enable building space landlords to cope with the fast pace of new space design requirements. The described inventions are a software tool in the cloud or customer computer system. It may provide per an existing empty building space multiple options which can be offered to a potential tenant and then adapted to their specific needs with a guidance for quick reassembly.

3 objectives of the invention are described:
1. Per landlords' guidelines, provide a set of potential floor plans (e.g. 3 law offices, 2 tech, 2 architect)
2. Per tenant guidelines, adapt a selected floor plan for their specific needs
3. Per generated floor plan and existing modular building elements, generate guidance for reassembly.

The invention is based on:
1. Relevant existing design data gathering;
2. Data extraction;
3. AI requirement and query preparation;
4. Floor plan.
5. Assembly guide.

### BRIEF DESCRIPTION OF THE DRAWINGS

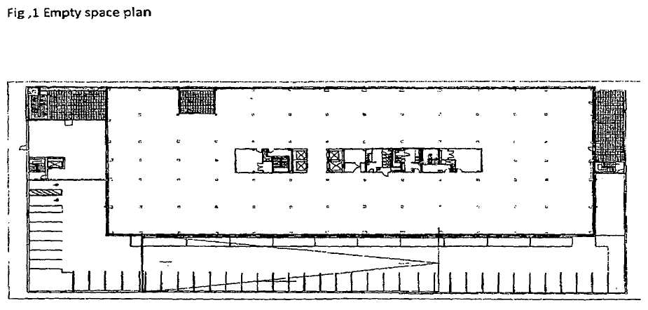

1. FIG. 1 describes an empty office space

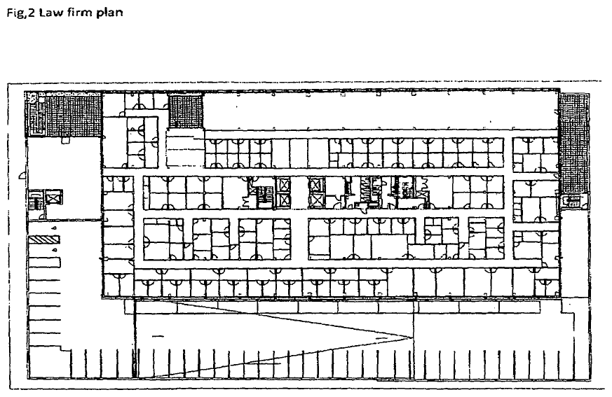

2. FIG. 2 describes a law firm in the office space above

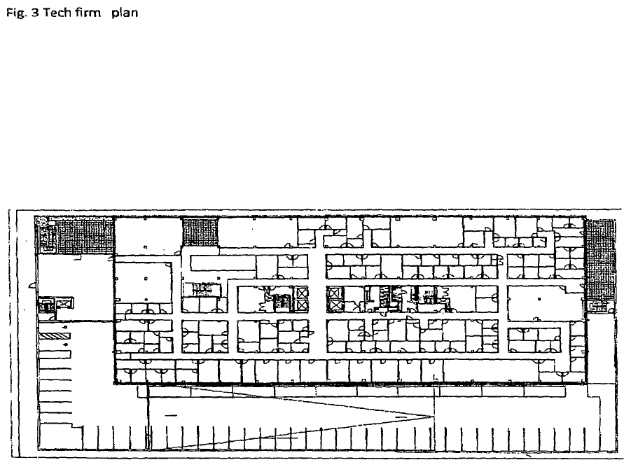

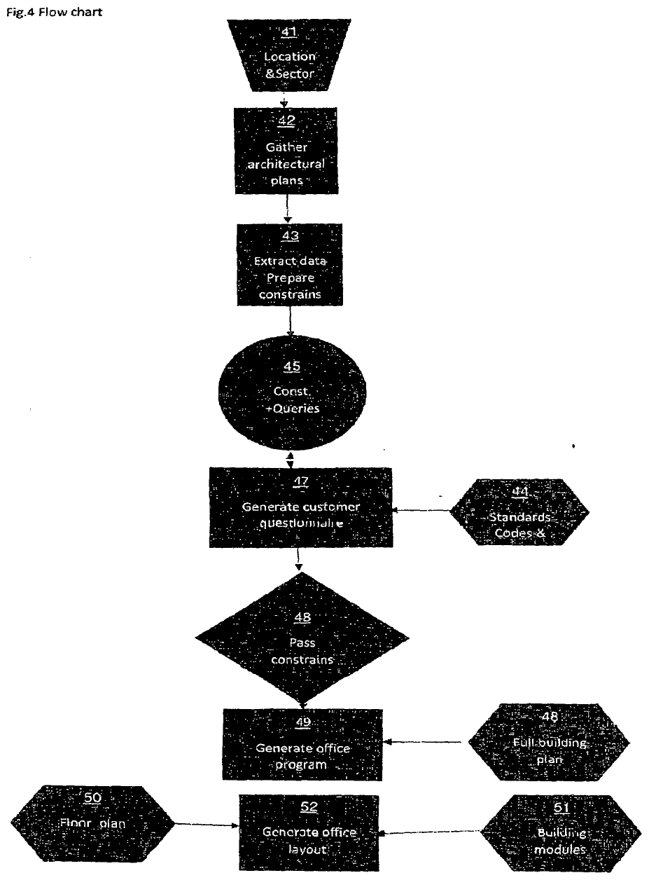

3. FIG. 3, describes a tech firm in the office space above

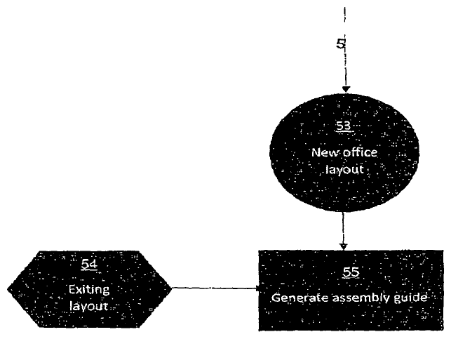

4. FIG. 4 describes the method flow chart.

### DETAILED PRESENT INVENTION DESCRIPTION.

The description is based on the flow chart in FIG. 4.

41 The high-level landlord requirements are set. This may be one specific geographical location (e.g. Brooklyn) or more (Brooklyn and Queens), category sector or sectors (e.g. law and advertisement offices) and office size range. For the primary design phase of preparing multiple multi sector plans the landlord guidelines are very important, they include: Site skeleton plan (Target Floor plan), Target sectors, Design guidelines and of course target budget.

42 The tool may perform a search automatically using Google and known search terms to get to a large list of architecture plans which adhere to the landlord top requirements.

The data is organized such that it allows for a data extraction Data may also be gathered from clients or partners.

43 The data may be extracted and organized in an AI platform with a list of requirement and potential queries. The architectural plans are organized in rooms with geometric information and also information on the room type. As can be observed, in a certain empty floor plan in FIG. 1 there can be very different plans for o law office in FIG. 2 or a tech office in FIG. 3.

The extracted information may be sector/vertical/customer-type/city/region/client information, Geometric data—2D or 3D plan, Room type (kitchen, office, meeting room, corridor, etc.), MEP—Mechanical Electrical Plumbing

The existing project plans contain all of this information. This is how buildings are built.

If the data is in a BIM (Building Information Modeling) format (as is mandated by modern codes) it can be extracted automatically with conventional industry tools like e.g. Autodesk Revit.

The extracted information may be:
Number of people per room
Proportion of rooms and room sizes per unit
Sizes and characteristics of meeting rooms
Private offices vs Open space
Avg. space per person per room type
Typical (Avg.) room count and mixture per-total property area.

A list of requirements may be prepared:
Let M be the number of sector-specific expected meeting rooms; and
Let P be the number of sector-specific expected private offices;
Then, a sector specific requirement may be:
2×M≤P: There are at least twice as many private offices as meeting rooms.

Room adjacency is another form of constraint, which can be specified as:
Which rooms share a common wall
How room types are clustered within the floor
The relation between doors and corridors
Egress and traversal distances within the floorplan between rooms and other interest points like fire escapes, restrooms and kitchens.

The tool may prepare a list of requirements which may be ranges of values of mathematical equations or a list of queries which may allow for next processing steps to ask certain queries and get the relevant answers. This AI database or platform is prepared in step 45.

The tool may generate also MEP—Mechanical Electrical Plumbing requirements.

In step 47 a detailed customer questionnaire may be prepared based on the AI database or platform 45.

The questionnaire 47 may include questions on the number of partners in the law firm and the number of employees and the type of meeting rooms and the required distance from the kitchen to the big meeting room or any other questions relating to the unit space requirements and organization. The questionnaire may allow the customer to specify ranges of values for each requirement.

Based on the customer answer to this questionnaire and to the list and codes and standards input 44. It may be verified in step 48 if the customer detailed requirements are matching the requirement and security requirements—for example there is no room for so many employees or the kitchen is too close to the restrooms. In this case the customer may have to adjust step 47.

A new office program may be generated in step 49. It may include a list of rooms with a size and category per room as well as room proximity requirements and also MEP—Mechanical Electrical Plumbing requirements.

It may consider a full building plan 48. It will be appreciated that there may be an additional customer requirement for one or more sector or location, under which relevant queries can be sent to the AI database or platform such that the generated plan may take into consideration the other set of requirements as well such that it may be easy to convert from one set of requirements to the other. Under another embodiment, the future tenant is receiving the landlord existing program 50 and may ask for a new program 49.

Based on the new office program and the empty floor plan 56 as in FIG. 1 a new office plan may be generated in step 52. It may consider building modules 51.

A new office plan 53 is generated. It may include:
1. 2D plan diagrams of the walls, ceiling and MEP systems
2. 3D plan diagrams and models of the walls, ceiling and MEP systems
3. The diagrams above, with the individual modules specified in each plan diagram.

It is expected that the design is based on modular element such as modular walls which allow fast reconstruction. The unit's sizes, production times, model variability (clear, opaque . . . ) and prices are very important.

In step 55 an assembly guide is prepared. Under another embodiment if may consider existing plan 54 It may prepare the following list of items:
1. A Bill-of-Materials for the desired suppliers
2. A shop-drawing and purchase order describing the supplier part numbers and counts required for the project.
3. Assembly instructions
4. Re-assembly instructions for switching between alternative designs.

What is claimed is:

1. A method for automatically generating one or more building space floor programs and plans comprising gathering public and proprietary floor plan information and extracting relevant data, receiving customer guidelines and data and based on this information generating one or more floor plans.

2. A method as in claim 1 wherein an AI database or platform of requirements and queries is prepared.

3. A method as in claim 2 wherein a floor program is generated based on a detailed list of customer requirements.

4. A method as in claim 3 wherein a floor plan is generated using and empty floor plan.

5. A method as in claim 1 wherein reassembly guidelines is generated from one space plan to the other using the same modular building elements.
